(19) United States
(12) Patent Application Publication
(10) Pub. No.: US 2017/0193938 A1
(43) Pub. Date: Jul. 6, 2017

(54) SHIFT REGISTER UNIT, SHIFT REGISTER, GATE DRIVING CIRCUIT AND DISPLAY APPARATUS

(71) Applicants: BOE Technology Group Co., Ltd., Beijing (CN); Hefei BOE Optoelectronics Technology Co., Ltd., Anhui (CN)

(72) Inventors: Silin Feng, Beijing (CN); Hongmin Li, Beijing (CN)

(21) Appl. No.: 15/251,199

(22) Filed: Aug. 30, 2016

(30) Foreign Application Priority Data
Jan. 5, 2016 (CN) 201610007040.8

(51) Int. Cl. G09G 3/36

(52) U.S. Cl. CPC G09G 3/3648; G09G 2310/08

(57) ABSTRACT

The present disclosure provides a shift register unit, a shift register, a gate driving circuit and a display apparatus. The shift register unit comprises an input module, a pull-up module, a pull-down module, a pull-down control module and a storage module. With the above shift register unit according to the present disclosure, it is possible to reduce noise in an output signal, so as to improve the accuracy of the output signal. On the other hand, it is possible to provide a reduced number of TFTs, a simplified circuit structure, a decreased area to be occupied, and thus a narrowed width of a rim of a display apparatus.

### CROSS-REFERENCE TO RELATED APPLICATION

This application claims the benefit of Chinese Patent Application No. 201610007040.8, filed on Jan. 5, 2016, in the State Intellectual Property Office of China, the whole disclosure of which is incorporated herein by reference.

### TECHNICAL FIELD

The present disclosure relates to a display technology, and more particularly, to a shift register unit, a shift register, a gate driving circuit and a display apparatus.

### BACKGROUND

In a Thin Film Transistor (TFT) or Organic Light Emitting Diode (OLED) display apparatus, a gate driving circuit is used for driving respective lines of pixels to be enabled sequentially for writing data signals and thus displaying. The gate driving circuit enables the respective lines of pixels “sequentially” by using a shift register unit including a plurality of stages of cascaded shift register units.

FIG. 1 shows a circuit diagram of a conventional shift register unit. The shift register unit includes first to ninth transistors M1˜M9 and a capacitor Cl connected as shown in FIG. 1. The first to ninth transistors M1˜M9 are all N-type transistors. FIG. 2 is a schematic diagram showing a timing sequence for respective signals in the circuit shown in FIG. 1. As shown in FIG. 2, in order to enable one pixel line, in the shift register unit corresponding to the pixel line, first during a period t1, a first input signal, IN1, is at a low level, a second input signal, IN2, is at the low level, a clock signal, CLK, is at the low level initially and then becomes high, and a pull-up node, PU, is maintained at the low level. With this timing sequence, the first transistor M1, the second transistor M2, the third transistor M3 and the fourth transistor M4 are turned off. When the clock signal CLK becomes high, the eighth transistor M8 and the fifth transistor M5 are turned on. In turn, a pull-down node, PD, becomes high and the ninth transistor M9 is turned on. In this case, a low level input terminal, VSS, is connected to a signal output terminal, OUTPUT, for noise reduction at the signal output terminal OUTPUT. During a period t2, the first input signal IN1 is at the high level, the second input signal IN2 is at the low level, and the clock signal CLK is at the low level. With this timing sequence, the first transistor M1 and the third transistor M3 are turned on, the second transistor M2 and the fourth transistor M4 are turned off, the PU is at the high level and charges the capacitor C1, and the clock signal CLK is inputted to the signal output terminal OUTPUT. In this case, a low level signal is outputted at the signal output terminal OUTPUT. During a period t3, the first input signal IN1 is at the low level, the second input signal IN2 is at the low level, and the clock signal CLK is at the high level. With this timing sequence, the first transistor M1, the second transistor M2 and the fourth transistor M4 are turned off, such that the PU is maintained at the high level and the third transistor M3 remains on. In turn, the clock signal CLK continues to be inputted to the output terminal OUTPUT. Hence, a high level signal is outputted at the signal output terminal OUTPUT, such that the sixth transistor M6 and the seventh transistor M7 are turned on. In turn, the fifth transistor M5 is turned off and the PD is at the low level. Accordingly, the ninth transistor M9 is turned off, such that the low level input terminal VSS is not connected to the signal output terminal OUTPUT, thereby ensuring the stability of the high level signal outputted at the signal output terminal OUTPUT. During a period t4, the first input signal IN1 is at the low level, the second input signal IN2 is at the high level, and the clock signal CLK is at the low level. With this timing sequence, the first transistor M1 is turned off and the second transistor M2 and the fourth transistor M4 are turned on, such that the PU and the capacitor C1 are charged and become low. The third transistor M3 is turned off. The low level input terminal VSS is connected to the signal output terminal OUTPUT, such that a low level signal is outputted at the signal output terminal OUTPUT. With the above process, one pixel line corresponding to the shift register unit can be enabled. Then, for enabling the pixel line next time, the process including the periods t1 to t4 will be repeated.

In the above shift register unit, as shown in FIG. 2, the PU is susceptible to noise and thus has a poor stability. Further, when the PU and the clock signal CLK are both at the high level, the fifth transistor M5, the sixth transistor M6, the seventh transistor M7 and the eighth transistor M8 are needed to set the PD to the low level. In this case, there are a large number of TFTs in each stage of shift register unit, which increases the area occupied by the shift register and has a high power consumption in operation.

### SUMMARY

In order to solve at least one of the above technical problems, the present disclosure provides a shift register unit, a shift register, a gate driving circuit and a display apparatus, capable of providing a reduced number of TFTs, a simplified circuit structure, a decreased area to be occupied, and thus a narrowed width of a rim of a display apparatus. Meanwhile, it is possible to apply noise reduction to the signals at a pull-up node and a signal output terminal.

In order to achieve the above object of the present disclosure, a shift register unit is provided. The shift register unit comprises: an input module having a control terminal connected to a signal input terminal, an input terminal connected to a first voltage input terminal, and an output terminal connected to a pull-up node, the input module being configured to provide a signal at the first voltage input terminal to the pull-up node under control of the signal input terminal; a pull-up module having a control terminal connected to the pull-up node, an input terminal connected to a clock signal input terminal and an output terminal connected to a signal output terminal of the shift register unit, the pull-up module being configured to pull up an output signal at the signal output terminal under control of the pull-up node; a pull-down control module having a first control terminal and a first input terminal connected to the clock signal input terminal, a first output terminal and a second input terminal connected to a pull-down node, a second control terminal connected to the signal output terminal, and a second output terminal connected to a low level input terminal, the pull-down control module being configured to maintain the pull-down node at a low level under joint control of the clock signal input terminal and the signal output terminal; a pull-down module having a first control terminal and a second control terminal connected to the pull-down node, a first input terminal connected to the signal output terminal, a second input terminal connected to the pull-up node, a first output terminal and a second output terminal connected to the low level input terminal, the pull-down module being configured to pull down the output signal at the signal output terminal under control of the pull-down node; and a storage module having a terminal connected to the pull-up node and another terminal connected to the low level input terminal, the storage module being configured to stabilize a potential at the pull-up node.

Optionally, the input module comprises a first transistor having its gate serving as the control terminal of the input module, its source serving as the input terminal of the input module, and its drain serving as the output terminal of the input module.

Optionally, the shift register unit further comprises: a reset module having a control terminal connected to a reset signal input terminal, an input terminal connected to the pull-up node, and an output terminal connected to a second voltage input terminal, the reset module being configured to reset the control terminal of the pull-up module.

Optionally, the reset module comprises a second transistor having its gate serving as the control terminal of the reset module, its source serving as the input terminal of the reset module, and its drain serving as the output terminal of the reset module. A low level signal can be inputted at the second voltage input terminal.

Optionally, the pull-up module comprises a third transistor having its gate serving as the control terminal of the pull-up module, its source serving as the input terminal of the pull-up module, and its drain serving as the output terminal of the pull-up module.

Optionally, the pull-down module comprises a fourth transistor having its gate serving as the first control terminal of the pull-down module, its source serving as the first input terminal of the pull-down module, and its drain serving as the first output terminal of the pull-down module.

Optionally, the pull-down module further comprises a seventh transistor having its gate serving as the second control terminal of the pull-down module, its source serving as the second input terminal of the pull-down module, and its drain serving as the second output terminal of the pull-down module.

Optionally, the pull-down control module comprises: a fifth transistor having its gate and source serving as the first control terminal and the first input terminal of the pull-down control module, respectively, and its drain serving as the output terminal of the pull-down control module; and a sixth transistor having its gate serving as the second control terminal of the pull-down control module, its source serving as the second input terminal of the pull-down control module, and its drain. The fifth transistor has a smaller width-to-length ratio than the sixth transistor.

Optionally, a ratio of the width-to-length ratio of the fifth transistor to that of the sixth transistor ranges from 1:3 to 1:5.

Optionally, when a high level voltage is inputted at the first voltage input terminal, a low level voltage is inputted at the second voltage input terminal; or when a low level voltage is inputted at the first voltage input terminal, a high level voltage is inputted at the second voltage input terminal.

Optionally, the storage module comprises a capacitor having a terminal connected to the pull-up node and another terminal connected to the low level input terminal.

According to another embodiment, a shift register is provided. The shift register comprises a plurality of stages of cascaded shift register units as described above.

According to another embodiment, a gate driving circuit is provided. The gate driving circuit comprises the above shift register.

According to another embodiment, a display apparatus is provided. The display apparatus comprises the above gate driving circuit.

In the shift register unit according to the present disclosure, when the node between the input module and the pull-up module, i.e., the pull-up node PU, is at the low level and the clock signal outputted from the clock signal input terminal is at the high level, the pull-up module is enabled to connect the PU and the signal output terminal of the shift register unit to the low level input terminal for noise reduction at the PU and the signal output terminal. Thus, the impact of the noise on the voltage at the PU can be reduced, such that the voltage at the PU can be more stable and the stability of the output signal can be improved. Further, when the PU and the clock signal outputted from the clock signal input terminal are both at the high level, the ratio between the width-to-length ratios of the individual transistors in the pull-down module can be set to provide a low level at the node between the pull-down module and the pull-down control module, i.e., the pull-down node PD, so as to prevent the pull-down module from being connected to the signal output terminal. Compared with the conventional solution, the number of TFTs can be reduced, so as to simplify the circuit structure reduce the area occupied by the shift register unit, thereby reducing the width of the rim of the display apparatus.

With the shift register, gate driving circuit and display apparatus according to the present disclosure, which incorporate the above shift register unit according to the present disclosure, it is possible to reduce noise in the output signal, so as to improve the accuracy of the output signal. On the other hand, it is possible to provide a reduced number of TFTs, a simplified circuit structure, a decreased area to be occupied, and thus a narrowed width of a rim of a display apparatus.

### BRIEF DESCRIPTION OF THE DRAWINGS

The figures, which constitute a part of the description, are provided to facilitate better understanding of the present disclosure. The figures, along with the following embodiments, are used for explaining, rather than limiting, the present disclosure, in which:

FIG. 1 is a circuit diagram of a conventional shift register unit;

FIG. 2 is schematic diagram showing a timing sequence for the individual signals in the circuit diagram of FIG. 1;

FIG. 3 is a circuit diagram of a shift register unit according to an embodiment of the present disclosure;

FIG. 4 is a schematic diagram showing a timing sequence for the individual signals in the circuit diagram of FIG. 3; and

FIG. 5 is a schematic diagram showing a shift register according to an embodiment of the present disclosure.

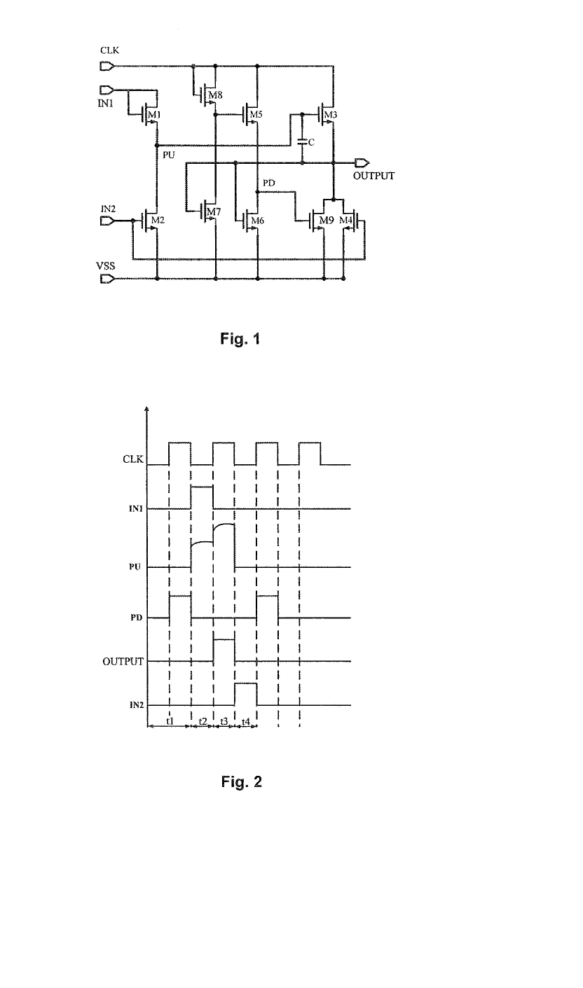

### REFERENCE NUMERALS

1: Input Module

2: Pull-up Module

3: Pull-down Module

4: Pull-down Control Module

5: Storage Module

6: Reset Module

### DETAILED DESCRIPTION OF THE EMBODIMENTS

In the following, the embodiments of the present disclosure will be explained in detail with reference to the figures. It should be noted that, the embodiments are described herein only for the purpose of explanation and illustration, rather than limiting the present disclosure.

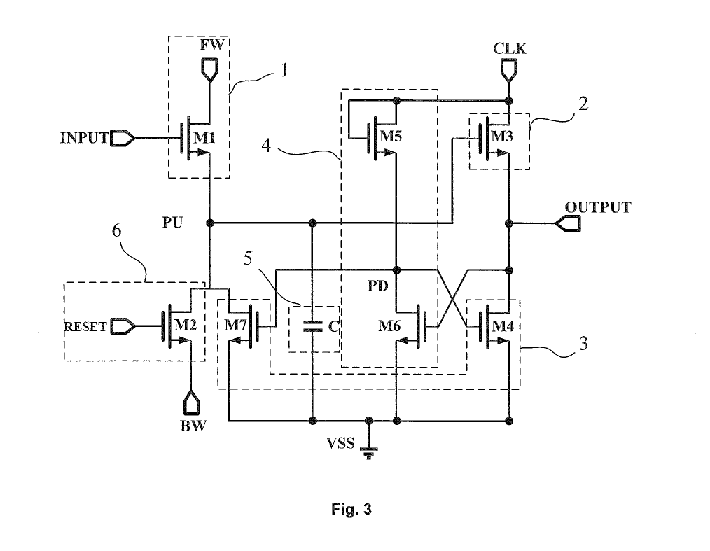

According to an embodiment of the present disclosure, a shift register unit is provided. FIG. 3 is a circuit diagram of a shift register unit according to an embodiment of the present disclosure. As shown in FIG. 3, the shift register unit in this embodiment includes an input module 1, a pull-up module 2, a pull-down module 3, a pull-down control module 4 and a storage module 5.

In particular, the input module 1 has a control terminal connected to a signal input terminal, INPUT, an input terminal connected to a first voltage input terminal, FW, and an output terminal connected to a pull-up node, PU. The input module 1 is configured to provide a signal at the first voltage input terminal F2 to the pull-up node PU under control of the signal input terminal INPUT.

The pull-up module 2 has a control terminal connected to the pull-up node PU, an input terminal connected to a clock signal input terminal, CLK, and an output terminal connected to a signal output terminal, OUTPUT, of the shift register unit. The pull-up module 2 is configured to pull up an output signal at the signal output terminal OUTPUT under control of the pull-up node PU.

The pull-down control module 4 has a first control terminal and a first input terminal connected to the clock signal input terminal CLK, a first output terminal and a second input terminal connected to a pull-down node, PD, a second control terminal connected to the signal output terminal OUTPUT, and a second output terminal connected to a low level input terminal VSS. The pull-down control module 4 is configured to maintain the pull-down node PD at a low level under joint control of the clock signal input terminal CLK and the signal output terminal OUTPUT.

The pull-down module 3 has a first control terminal and a second control terminal connected to the pull-down node PD, a first input terminal connected to the signal output terminal OUTPUT, a second input terminal connected to the pull-up node PU, a first output terminal and a second output terminal connected to the low level input terminal VSS. The pull-down module 3 is configured to pull down the output signal at the signal output terminal under control of the pull-down node PD.

The storage module 5 has a terminal connected to the pull-up node PU and another terminal connected to the low level input terminal VSS. The storage module 5 is configured to stabilize a potential at the pull-up node. As shown in FIG. 3, the input module 1 includes a first transistor M1 having its gate serving as the control terminal of the input module 1, its source serving as the input terminal of the input module 1, and its drain serving as the output terminal of the input module 1. The shift register unit can further include a reset module 6 having a control terminal connected to a reset signal input terminal, RESET, an input terminal connected to the pull-up node PU, and an output terminal connected to a second voltage input terminal BW. The reset module is configured to reset the control terminal of the pull-up module 2. The reset module 6 includes a second transistor M2 having its gate connected to the reset signal input terminal RESET and serving as the control terminal of the reset module 6, its source connected to the pull-up node PU and serving as the input terminal of the reset module 6, and its drain connected to the second voltage input terminal BW and serving as the output terminal of the reset module. In this embodiment, a low level signal can be inputted at the second voltage input terminal BW.

The pull-up module 2 includes a third transistor M3 having its gate connected to the pull-up node PU and serving as the control terminal of the pull-up module 2, its source connected to the clock signal input terminal CLK and serving as the input terminal of the pull-up module 2, and its drain connected to the signal output terminal OUTPUT and serving as the output terminal of the pull-up module 2.

The pull-down module 3 includes a fourth transistor M4 having its gate connected to the pull-down node PD and serving as the first control terminal of the pull-down module 3, its source connected to the signal output terminal OUTPUT and serving as the first input terminal of the pull-down module 3, and its drain connected to the low level input terminal VSS and serving as the first output terminal of the pull-down module 3.

The pull-down module 3 further includes a seventh transistor M7 having its gate connected to the pull-down node PD and serving as the second control terminal of the pull-down module, its source connected to the pull-up node PU and serving as the second input terminal of the pull-down module 3, and its drain connected to the low level input terminal VSS and serving as the second output terminal of the pull-down module 3.

The pull-down control module 4 includes a fifth transistor M5 and a sixth transistor M6. The fifth transistor M5 has its gate and source both connected to the clock signal input terminal CLK and serving as the first control terminal and the first input terminal of the pull-down control module 4, respectively, and its drain connected to the source of the sixth transistor M6 and serving as the output terminal of the pull-down control module 4. The sixth transistor M6 has its gate connected to the signal output terminal OUTPUT and serving as the second control terminal of the pull-down control module 4, its source serving as the second input terminal of the pull-down control module 4, and its drain connected to the low level input terminal VSS and serving as the second input terminal of the pull-down control module 4. The fifth transistor M5 has a smaller width-to-length ratio than the sixth transistor M6. Preferably, a ratio of the width-to-length ratio of the fifth transistor to that of the sixth transistor ranges from 1:3 to 1:5.

It is to be noted here that the transistors in the above embodiments of the present disclosure can be TFTs or Metal Oxide Semiconductor (MOS) transistors and the present disclosure is not limited to any of these. In the embodiments, the functions of the source and drain of each of these transistors may be exchanged depending on the type of the transistor and the signal inputted to the transistor. The present disclosure is not limited to this.

The storage module 5 can be a capacitor C having a first terminal connected to the pull-up node PU and a second terminal connected to the low level input terminal VSS.

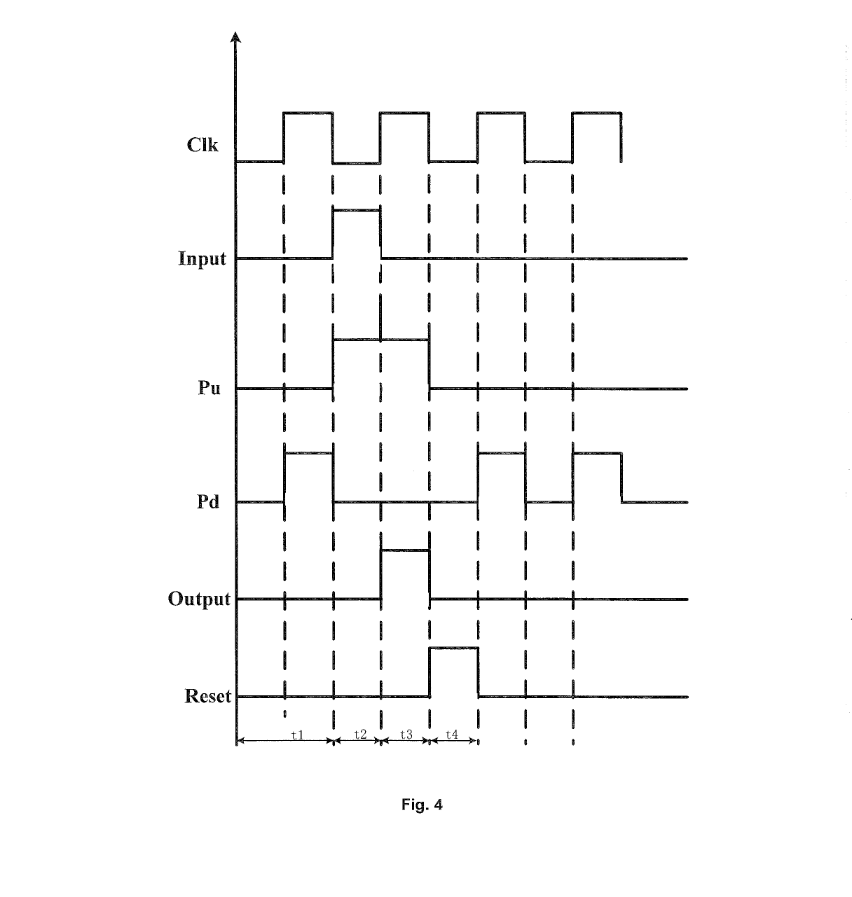

FIG. 4 is a schematic diagram showing a timing sequence for the individual signals in the circuit diagram of FIG. 3. As shown in FIG. 4, during a period t1, a signal, input, outputted from the signal input terminal INPUT is at the low level. A signal Clk, outputted from the clock signal input terminal CLK is at the low level initially and then becomes high. A signal, reset, outputted from the reset signal input terminal RESET is at the low level and the pull-up node PU is maintained at the low level. With the above timing sequence of the signals, the first to third transistors M1˜M3 are turned off. When the signal Clk becomes high, the fifth transistor M5 is turned on and the pull-down node PD is at the high level, such that the fourth transistor M4 and the seventh transistor M7, having their gates connected to the pull-down node PD, are turned on. The fourth transistor M4 being turned on causes the low level input terminal VSS to be connected to the signal output terminal OUTPUT, for noise reduction for the signal at the signal output terminal OUTPUT. The seventh transistor M7 being turned on causes the pull-up node PU to be connected to the low level input terminal VSS, so as to maintain the potential at the pull-up node PU at the low level.

During a period t2, the signal Input outputted from the signal input terminal INPUT is at the high level, the signal Clk outputted from the clock signal input terminal CLK is at the low level, and the signal Reset outputted from the reset signal input terminal RESET is at the low level. With the above timing sequence of the signals, the first transistor M1 is turned on, the second transistor M2 is turned off, and the fifth transistor M5 is turned off. The potential at the pull-down node PD becomes low, such that the fourth transistor M4 and the seventh transistor M7 are turned off. The potential at the pull-up node PU becomes high, such that the third transistor M3 is turned on. In this case, the clock signal input terminal CLK is connected to the signal output terminal OUTPUT and a low level signal is outputted at the signal output terminal OUTPUT. The signal Clk is also inputted to the gate of the sixth transistor M6 to turn off the sixth transistor M6. Meanwhile, the capacitor C is charged during this period, so as to stabilize the potential at the pull-up node PU and reduce the impact of the noise on the pull-up node PU, thereby stabilizing the signal outputted at the signal output terminal OUTPUT.

During a period t3, the signal Input outputted from the signal input terminal INPUT is at the low level, the signal Clk outputted from the clock signal input terminal CLK is at the high level, and the signal Reset outputted from the reset signal input terminal RESET is at the low level. With the above timing sequence of the signals, the first transistor M1 is turned off, the second transistor M2 is turned off, and the fifth transistor M5 is turned on. Since the capacitor C has been charged during the period t2, the pull-up node PU remains at the high level and the third transistor M3 is turned on, i.e., the clock signal input terminal CLK is connected to the signal output terminal OUTPUT. Further, the signal Clk is also inputted to the gate of the sixth transistor M6 to turn on the sixth transistor M6. In this embodiment, the ratio of the width-to-length ratio of the fifth transistor to that of the sixth transistor can be set to e.g., 1:5, such that the pull-down node PD is at the low level while the fifth transistor M5 and the sixth transistor M6 are both on, thereby turning off the fourth transistor M4 and the seventh transistor M7. It can be seen that the signal output terminal OUTPUT is connected only to the clock signal input terminal CLK, but not to the low level input terminal VSS. Hence, a high level signal can be outputted at the signal output terminal OUTPUT.

During a period t4, the signal Input outputted from the signal input terminal INPUT is at the low level, the signal Clk outputted from the clock signal input terminal CLK is at the low level, and the signal Reset outputted from the reset signal input terminal RESET is at the high level. With the above timing sequence of the signals, the first transistor M1 is turned off and the second transistor M2 is turned on. The signal Reset is inputted to the pull-up node PU and the capacitor C to reset the pull-up node PU to the low level. The capacitor C is discharged. In this case, a low level signal can be outputted at the signal output terminal OUTPUT.

As described above, when the pull-up node PU and the signal Clk are both at the high level (i.e., during the period t3), the ratio of the width-to-length ratio of the fifth transistor to that of the sixth transistor can be set to provide a low level at the pull-down node PD. Compared with the conventional solution, the number of TFTs can be reduced, so as to simplify the circuit structure reduce the area occupied by the shift register unit, thereby reducing the width of the rim of the display apparatus. Further, when the pull-up node PU is at the low level and the signal Clk is at the high level, the fourth transistor M4 and the seventh transistor M7 are turned on to connect the pull-up node PU and the signal output terminal OUTPUT to the low level input terminal VSS for noise reduction at the pull-up node PU and the signal output terminal OUTPUT. Thus, the impact of the noise on the voltage at the pull-up node PU can be reduced, such that the voltage at the pull-up node PU can be more stable.

It is to be noted that, in the above embodiment, a high level voltage is inputted at the first voltage input terminal FW and a low level voltage is inputted at the second voltage input terminal BW. However, in practice, as an alternative, a low level voltage can be inputted at the first voltage input terminal FW and a high level voltage can be inputted at the second voltage input terminal BW. In this case, the shift register unit provides a reverse scan. Hence, a bi-directional scan can be provided by converting the signals between the first voltage input terminal FW and the second voltage input terminal BW.

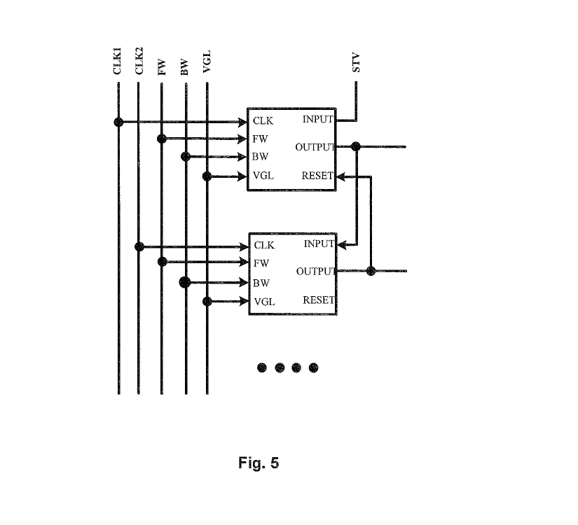

According to another embodiment of the present disclosure, a shift register is provided. FIG. 5 is a schematic diagram showing a shift register according to an embodiment of the present disclosure. As shown in FIG. 5, the shift register in this embodiment includes a plurality of stages of cascaded shift register units as described in connection with the above embodiments.

As shown in FIG. 5, the reset signal for the shift register unit at each stage is a signal outputted from the signal output terminal OUTPUT of the shift register unit at the next stage. The signal Input outputted from the signal input terminal INPUT of the shift register unit at the first stage is derived from an STV signal. The signal Input outputted from the signal input terminal of the shift register unit at each subsequent stage is derived from the output signal from the signal output terminal OUTPUT of the shift register unit at its previous stage.

With the shift register according to the embodiment of the present disclosure, which incorporates the above shift register unit according to the embodiment of the present disclosure, it is possible to reduce noise in the output signal, so as to improve the accuracy of the output signal. On the other hand, it is possible to provide a reduced number of TFTs, a simplified circuit structure, a decreased area to be occupied, and thus a narrowed width of a rim of a display apparatus.

According to another embodiment of the present disclosure, a gate driving circuit is provided. In this embodiment, the gate driving circuit includes the shift register according to the above embodiment of the present disclosure.

With the gate driving circuit according to the embodiment of the present disclosure, which incorporates the above shift register according to the embodiment of the present disclosure, it is possible to reduce noise in the output signal, so as to improve the accuracy of the output signal. On the other hand, it is possible to provide a reduced number of TFTs, a simplified circuit structure, a decreased area to be occupied, and thus a narrowed width of a rim of a display apparatus.

According to another embodiment of the present disclosure, a display apparatus is provided. In this embodiment, the display apparatus includes the gate driving circuit according to the above embodiment of the present disclosure.

With the display apparatus according to the embodiment of the present disclosure, which incorporates the above gate driving circuit according to the embodiment of the present disclosure, it is possible to reduce noise in the output signal, so as to improve the accuracy of the output signal. On the other hand, it is possible to provide a reduced number of TFTs, a simplified circuit structure, a decreased area to be occupied, and thus a narrowed width of a rim of the display apparatus.

It can be appreciated that the above embodiments are illustrative only and provided for explaining the principles of the present disclosure, rather than limiting the scope of the present disclosure. Various variants and modifications can be made by those skilled in the art without departing from the spirit and scope of the present disclosure. These variants and modifications are to be encompassed by the scope of the present disclosure.

What is claimed is:

1. A shift register unit, comprising:
an input module having a control terminal connected to a signal input terminal, an input terminal connected to a first voltage input terminal, and an output terminal connected to a pull-up node, the input module being configured to provide a signal at the first voltage input terminal to the pull-up node under control of the signal input terminal;
a pull-up module having a control terminal connected to the pull-up node, an input terminal connected to a clock signal input terminal, and an output terminal connected to a signal output terminal of the shift register unit, the pull-up module being configured to pull up an output signal at the signal output terminal under control of the pull-up node;
a pull-down control module having a first control terminal and a first input terminal connected to the clock signal input terminal, a first output terminal and a second input terminal connected to a pull-down node, a second control terminal connected to the signal output terminal, and a second output terminal connected to a low level input terminal, the pull-down control module being configured to maintain the pull-down node at a low level under joint control of the clock signal input terminal and the signal output terminal;
a pull-down module having a first control terminal and a second control terminal connected to the pull-down node, a first input terminal connected to the signal output terminal, a second input terminal connected to the pull-up node, a first output terminal and a second output terminal connected to the low level input terminal, the pull-down module being configured to pull down the output signal at the signal output terminal under control of the pull-down node; and
a storage module having a terminal connected to the pull-up node and another terminal connected to the low level input terminal, the storage module being configured to stabilize a potential at the pull-up node.

2. The shift register unit of claim 1, wherein the input module comprises a first transistor having its gate serving as the control terminal of the input module, its source serving as the input terminal of the input module, and its drain serving as the output terminal of the input module.

3. The shift register unit of claim 1, further comprising:
a reset module having a control terminal connected to a reset signal input terminal, an input terminal connected to the pull-up node, and an output terminal connected to a second voltage input terminal, the reset module being configured to reset the control terminal of the pull-up module.

4. The shift register unit of claim 3, wherein the reset module comprises a second transistor having its gate serving as the control terminal of the reset module, its source serving as the input terminal of the reset module, and its drain serving as the output terminal of the reset module, and
wherein a low level signal can be inputted at the second voltage input terminal.

5. The shift register unit of claim 1, wherein the pull-up module comprises a third transistor having its gate serving as the control terminal of the pull-up module, its source serving as the input terminal of the pull-up module, and its drain serving as the output terminal of the pull-up module.

6. The shift register unit of claim 1, wherein the pull-down module comprises a fourth transistor having its gate serving as the first control terminal of the pull-down module, its source serving as the first input terminal of the pull-down module, and its drain serving as the first output terminal of the pull-down module.

7. The shift register unit of claim 6, wherein the pull-down module further comprises a seventh transistor having its gate serving as the second control terminal of the pull-down module, its source serving as the second input terminal of the pull-down module, and its drain serving as the second output terminal of the pull-down module.

8. The shift register unit of claim 1, wherein the pull-down control module comprises:
a fifth transistor having its gate and source serving as the first control terminal and the first input terminal of the pull-down control module, respectively, and its drain serving as the output terminal of the pull-down control module; and
a sixth transistor having its gate serving as the second control terminal of the pull-down control module, its source serving as the second input terminal of the pull-down control module, and its drain serving as the second input terminal of the pull-down control module, and
wherein the fifth transistor has a smaller width-to-length ratio than the sixth transistor.

9. The shift register unit of claim 8, wherein a ratio of the width-to-length ratio of the fifth transistor to that of the sixth transistor ranges from 1:3 to 1:5.

10. The shift register unit of claim 3, wherein, when a high level voltage is inputted at the first voltage input terminal, a low level voltage is inputted at the second voltage input terminal; or when a low level voltage is inputted at the first voltage input terminal, a high level voltage is inputted at the second voltage input terminal.

11. The shift register unit of claim 1, wherein the storage module comprises a capacitor having a terminal connected to the pull-up node and another terminal connected to the low level input terminal.

12. A shift register, comprising a plurality of stages of cascaded shift register units each according to claim 1.

13. A gate driving circuit, comprising the shift register according to claim 12.

14. A display apparatus, comprising the gate driving circuit according to claim 13.
